(19) United States
(12) Patent Application Publication
(10) Pub. No.: US 2013/0107415 A1
(43) Pub. Date: May 2, 2013

(54) ELECTROSTATIC CHUCK

(71) Applicant: APPLIED MATERIALS, INC., Santa Clara, CA (US)

(72) Inventors: SAMER BANNA, San Jose, CA (US); VALENTIN TODOROW, Palo Alto, CA (US); DMITRY LUBOMIRSKY, Cupertino, CA (US)

(73) Assignee: APPLIED MATERIALS, INC., Santa Clara, CA (US)

(21) Appl. No.: 13/646,330

(22) Filed: Oct. 5, 2012

Related U.S. Application Data
(60) Provisional application No. 61/552,567, filed on Oct. 28, 2011.

(51) Int. Cl. H02N 13/00

(52) U.S. Cl. 361/234

(57) ABSTRACT

Embodiments of electrostatic chucks are provided herein. In some embodiments, an electrostatic chuck for supporting and retaining a substrate having a given width may include a dielectric member having a support surface configured to support a substrate having a given width; an electrode disposed within the dielectric member beneath the support surface and extending from a center of the dielectric member outward to an area beyond an outer periphery of the substrate as defined by the given width of the substrate; an RF power source coupled to the electrode; and a DC power source coupled to the electrode.

### CROSS-REFERENCE TO RELATED APPLICATIONS

This application claims benefit of U.S. provisional patent application Ser. No. 61/552,567, filed Oct. 28, 2011, which is herein incorporated by reference.

### FIELD

Embodiments of the present invention generally relate to a semiconductor processing.

### BACKGROUND

The inventors have observed that conventional electrostatic chucks utilized to secure a substrate in plasma processing chambers (e.g., etch chambers) may produce process non-uniformities proximate an edge of a substrate. Such process non-uniformities are typically caused by differing electrical and thermal properties of the materials used to fabricate components of the electrostatic chuck (e.g., process kit) and the substrate. Moreover, the inventors have observed that the conventional electrostatic chucks typically produce a non-uniform electromagnetic field above the substrate that causes a plasma to be formed having a plasma sheath that bends towards the substrate proximate the edge of the substrate. The inventors have further discovered that such bending of the plasma sheath leads to differences in the ion trajectories bombarding the substrate proximate the edge of the substrate as compared to the center of the substrate, thereby causing a non-uniform etching of the substrate, thus affecting overall critical dimension uniformity.

Therefore, the inventors have provided an improved electrostatic chuck.

### SUMMARY

Embodiments of electrostatic chucks are provided herein. In some embodiments, an electrostatic chuck for supporting and retaining a substrate having a given width may include a dielectric member having a support surface configured to support a substrate having a given width; an electrode disposed within the dielectric member beneath the support surface and extending from a center of the dielectric member outward to an area beyond an outer periphery of the substrate as defined by the given width of the substrate; an RF power source coupled to the electrode; and a DC power source coupled to the electrode.

In some embodiments, an electrostatic chuck for supporting and retaining a substrate having a given width may include a first electrode disposed within a dielectric member of an electrostatic chuck and passing through a central axis perpendicular to a support surface of the electrostatic chuck; a second electrode disposed within the dielectric member and at least partially radially outward of the first electrode, wherein the second electrode extends radially outward to an area beyond an outer periphery of the substrate as defined by the given width of the substrate; an RF power source and a DC power source each coupled to the first electrode; and an RF power source coupled to the second electrode.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 is a process chamber suitable for use with the inventive electrostatic chuck in accordance with some embodiments of the present invention

FIGS. 2-4 respectively depict electrostatic chucks in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention provide electrostatic chucks for processing a substrate. The inventive electrostatic chuck may advantageously facilitate the production of a uniform electromagnetic field above a substrate disposed atop the electrostatic chuck during plasma processing processes (e.g., etch processes) thereby reducing or eliminating a bending of a plasma sheath of a plasma formed above the substrate, thus preventing non-uniform etching of the substrate. The inventive electrostatic chuck may further advantageously provide a uniform temperature gradient proximate the edge of the substrate, thus reducing temperature-related process non-uniformities and providing improved critical dimension uniformity as compared to conventionally utilized electrostatic chucks. While not limiting in scope, the inventors have observed that the inventive apparatus may be particularly useful in applications such as etch process chambers utilized for the fabrication of 32 nm node technology and below devices, for example such as silicon or conductor etch processes, or the like, or patterning processes, for example such as double patterning or multiple applications.

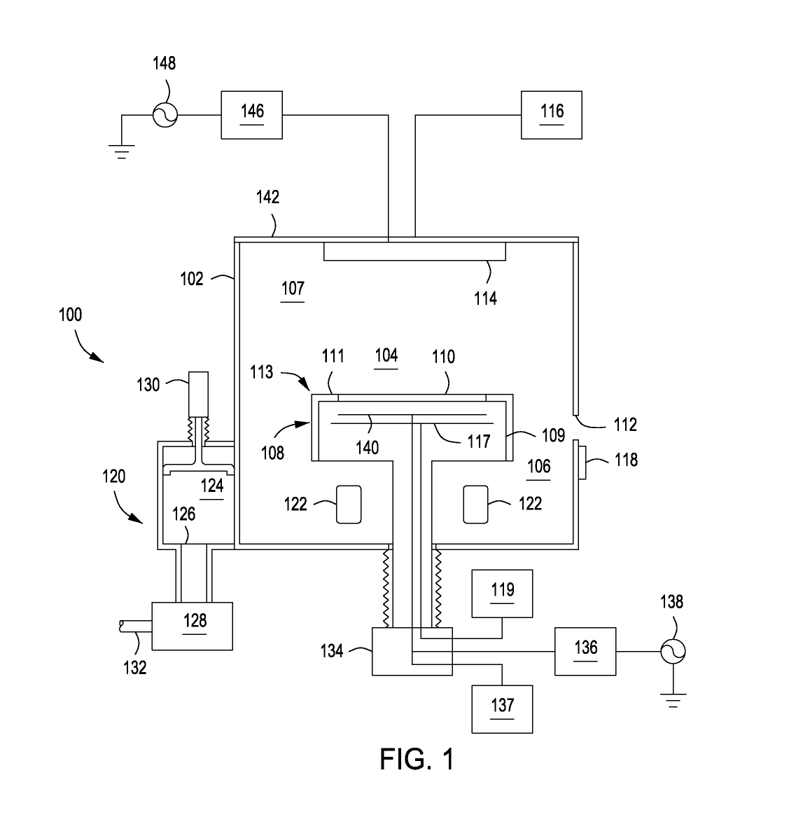

FIG. 1 depicts an illustrative process chamber 100 having an electrostatic chuck in accordance with some embodiments of the present invention. The process chamber 100 may comprise a chamber body 102 having a substrate support 108 comprising an electrostatic chuck 109 for retaining a substrate 110 and, in some embodiments, imparting a temperature profile to the substrate 110. Exemplary process chambers may include the DPS®, ENABLER®, SIGMA™, ADVANTEDGE™, or other process chambers, available from Applied Materials, Inc. of Santa Clara, Calif. It is contemplated that other suitable chambers may be suitably modified in accordance with the teachings provided herein, including those available from other manufacturers. Although the process chamber 100 is described having a particular configuration, electrostatic chucks as described herein may also be used in process chambers having other configurations.

The chamber body 102 has an inner volume 107 that may include a processing volume 104 and an exhaust volume 106. The processing volume 104 may be defined, for example, between a substrate support 108 disposed within the process chamber 102 for supporting a substrate 110 thereupon during processing and one or more gas inlets, such as a showerhead 114 and/or nozzles provided at desired locations.

The substrate 110 may enter the process chamber 100 via an opening 112 in a wall of the chamber body 102. The opening 112 may be selectively sealed via a slit valve 118, or other mechanism for selectively providing access to the interior of the process chamber 100 through the opening 112. The substrate support 108 may be coupled to a lift mechanism 134 that may control the position of the substrate support 108 between a lower position (as shown) suitable for transferring substrates into and out of the chamber via the opening 112 and a selectable upper position suitable for processing. The process position may be selected to maximize process uniformity for a particular process step. When in at least one of the elevated processing positions, the substrate support 108 may be disposed above the opening 112 to provide a symmetrical processing region.

The one or more gas inlets (e.g., the showerhead 114) may be coupled to a gas supply 116 for providing one or more process gases into the processing volume 104 of the process chamber 102. Although a showerhead 114 is shown in FIG. 1, additional or alternative gas inlets may be provided, such as nozzles or inlets disposed in the ceiling 142 or on the sidewalls of the process chamber 102 or at other locations suitable for providing gases as desired to the process chamber 102, such as the base of the process chamber, the periphery of the substrate support, or the like.

One or more plasma power sources (one RF power source 148 shown) may be coupled to the process chamber 102 to supply RF power to an upper electrode (e.g. the showerhead 114) via one or more respective match networks (one match network 146 shown). In some embodiments, the process chamber 100 may utilize inductively coupled RF power for processing. For example, the process chamber 102 may have a ceiling 142 made from a dielectric material and a dielectric showerhead 114. The ceiling 142 may be substantially flat, although other types of ceilings, such as dome-shaped ceilings or the like, may also be utilized. In some embodiments, an antenna comprising at least one inductive coil element (not shown) may be disposed above the ceiling 142. The inductive coil elements are coupled to one or more RF power sources (e.g., RF power source 148) through one or more respective matching networks (e.g., matching network 146). The one or more plasma sources may be capable of producing up to 5000 W at a frequency of about 2 MHz and/or about 13.56 MHz, or higher frequency, such as 27 MHz and/or 60 MHz. In some embodiments, two RF power sources may be coupled to the inductive coil elements through respective matching networks for providing RF power at frequencies of, for example, about 2 MHz and about 13.56 MHz.

The exhaust volume 106 may be defined, for example, between the substrate support 108 and a bottom of the process chamber 102. The exhaust volume 106 may be fluidly coupled to the exhaust system 120, or may be considered a part of the exhaust system 120. The exhaust system 120 generally includes a pumping plenum 124 and one or more conduits that couple the pumping plenum 124 to the inner volume 107 (and generally, the exhaust volume 104) of the process chamber 102.

Each conduit has an inlet 122 coupled to the inner volume 107 (or, in some embodiments, the exhaust volume 106) and an outlet (not shown) fluidly coupled to the pumping plenum 124. For example, each conduit may have an inlet 122 disposed in a lower region of a sidewall or a floor of the process chamber 102. In some embodiments, the inlets are substantially equidistantly spaced from each other.

A vacuum pump 128 may be coupled to the pumping plenum 124 via a pumping port 126 for pumping out the exhaust gases from the process chamber 102. The vacuum pump 128 may be fluidly coupled to an exhaust outlet 132 for routing the exhaust as required to appropriate exhaust handling equipment. A valve 130 (such as a gate valve, or the like) may be disposed in the pumping plenum 124 to facilitate control of the flow rate of the exhaust gases in combination with the operation of the vacuum pump 128. Although a z-motion gate valve is shown, any suitable, process compatible valve for controlling the flow of the exhaust may be utilized.

In some embodiments, the substrate support 108 may include a process kit 113 comprising, for example, an edge ring 111 disposed atop the substrate support 108. When present, the edge ring 111 may secure the substrate 110 in a suitable position for processing and/or protect the underlying substrate support 108 from damage during processing. The edge ring 111 may comprise any material suitable to secure the substrate 111 and/or protect the substrate support 108 while resisting degradation due to the environment produced within the process chamber 100 during processing. For example, in some embodiments, the edge ring 111 may comprise quartz (SiO₂).

In some embodiments, the substrate support 108 may include mechanisms for controlling the substrate temperature (such as heating and/or cooling devices) and/or for controlling the species flux and/or ion energy proximate the substrate surface. For example, in some embodiments, the substrate support 108 may include a heater 117, for example a resistive heater, powered by a power source 119 to facilitate controlling a temperature of the substrate support 108. In such embodiments, the heater 117 may comprise multiple zones independently operable to provide selective temperature control across the substrate support 108.

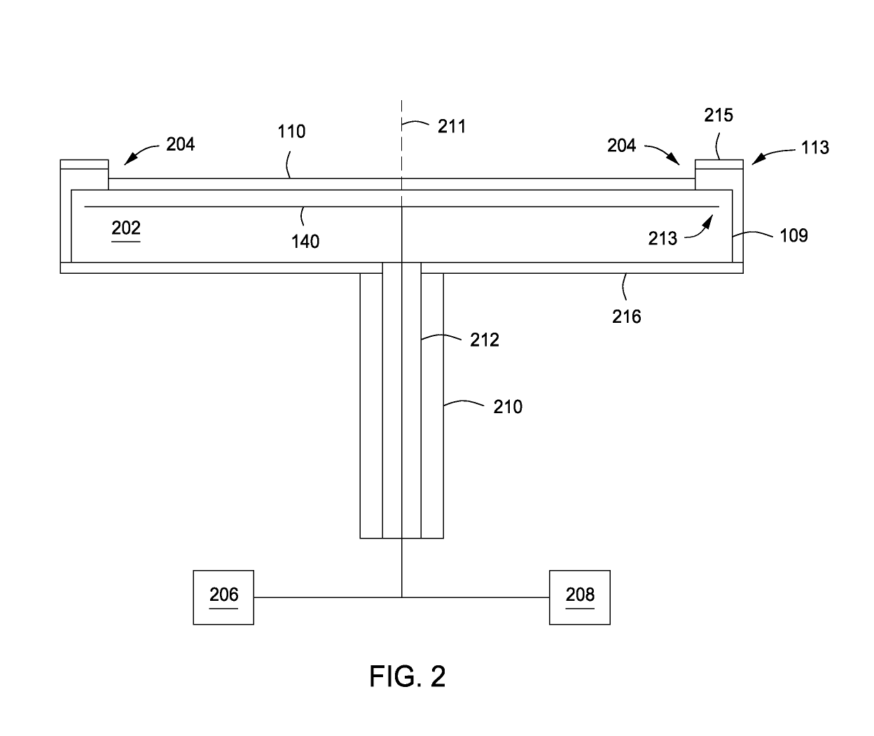

In some embodiments, the substrate support 108 may comprise a mechanism that retains or supports the substrate 110 on the surface of the substrate support 108, such as an electrostatic chuck 109. For example, in some embodiments, the substrate support 108 may include an electrode 140. In some embodiments, the electrode 140 (e.g., a conductive mesh) may be coupled to one or more power sources. For example, the electrode 140 may be coupled to a chucking power source 137, such as a DC or AC power supply. In some embodiments, the electrode 140 (or a different electrode in the substrate support) may be coupled to a bias power source 138 through a matching network 136. In some embodiments, the electrode 140 may be embedded in a portion of the electrostatic chuck 109. For example, the electrostatic chuck 109 may comprise a dielectric member having a support surface for supporting a substrate having a given width (e.g., 200 mm, 300 mm, or other sized silicon wafers or other substrates). In embodiments where the substrate is circular, the dielectric member may be in the form of a disc, or puck (dielectric member) 202, such as shown in FIG. 2. The puck 202 may be supported by a plate 216 disposed atop a substrate support pedestal 210. In some embodiments, the substrate support pedestal 210 may comprise a conduit 212 configured to allow process resources (e.g., RF or DC power) to be routed to the electrostatic chuck 109. The puck 202 may comprise any insulating materials suitable for semiconductor processing, for example, a ceramic such as alumina (Al2O3), silicon nitride (SiN), or the like.

The inventors have observed that in conventionally used substrate supports having process kits (e.g. the edge ring described above), process non-uniformities may occur proximate an edge of the substrate during processing due to the differing electrical and thermal properties of the materials used to fabricate the process kit and substrate. Moreover, the inventors have observed that conventional electrostatic chucks utilized in plasma processing chambers (e.g., etch chambers) typically do not extend beyond an edge of the substrate disposed on the electrostatic chuck. However, the inventors have discovered that, by not extending beyond an edge of the substrate, the electrostatic chuck produces an electromagnetic field above the substrate that causes a plasma to be formed above the substrate having a plasma sheath that bends towards the substrate proximate the edge of the substrate. Such bending of the plasma sheath leads to differences on the ion trajectories bombarding the substrate proximate the edge of the substrate as compared to the center of the substrate, thereby causing a non-uniform etching of the substrate, thus negatively affecting overall critical dimension uniformity.

Accordingly, in some embodiments, the electrode 140 of the electrostatic chuck 109 may extend from a center or central axis 211 of the puck 202 to an area 213 beyond an edge 204 of the substrate 110. The inventors have observed that by extending the electrode (conductive mesh) 140 beyond the edge 204 of the substrate 110 a more uniform electromagnetic field may be produced above the substrate 100, thereby reducing or eliminating a bending of the plasma sheath (as described above), thus limiting or preventing non-uniform etching of the substrate 110. The electrode 140 may extend beyond the edge of the substrate 110 any distance suitable to provide a more uniform electromagnetic field as described above, for example such as from less than about a millimeter to tens of millimeters. In some embodiments, the electrode 140 may extend beneath the process kit 113.

In some embodiments, two or more power sources, for example, such as a DC power source 206 and an RF power source 208 may be coupled to the electrode 140. In such embodiments, the DC power source 206 may provide a chucking power to facilitate securing the substrate 110 atop the electrostatic chuck 109 and the RF power may provide a processing power, for example a bias power to the substrate 110 to facilitate directing ions towards the substrate 110 in an etching process. Illustratively, in some embodiments, the RF power source may provide power up to about 12000 W at a frequency of up to about 60 MHz, or in some embodiments, about 400 kHz, or in some embodiments, about 2 MHz, or in some embodiments, about 13.56 MHz.

Alternatively, or in combination, in some embodiments, a layer 215 may be disposed atop the edge ring 111. When present, the layer 215 may have a thermal conductivity similar to that of the substrate 110, thereby providing a more uniform temperature gradient proximate the edge of the substrate 110, thus further reducing process non-uniformities (e.g., such as the non-uniformities discussed above). The layer 215 may comprise any material having the aforementioned thermal conductivity compatible with the particular process environment (e.g. etch environment). For example, in some embodiments, the layer 215 may comprise silicon carbide (SiC), doped diamond, for example such as boron doped diamond, or the like. In embodiments where the layer 215 comprises a doped material, for example, such as a doped diamond, the inventors have observed that the amount of dopant may be varied to control the electrical conductivity of the layer 215. By controlling the electrical conductivity of the layer 215, a more uniform electromagnetic field may be produced above the substrate 100, thereby reducing or eliminating a bending of the plasma sheath, thus limiting or preventing non-uniform etching of the substrate 110 (as described above).

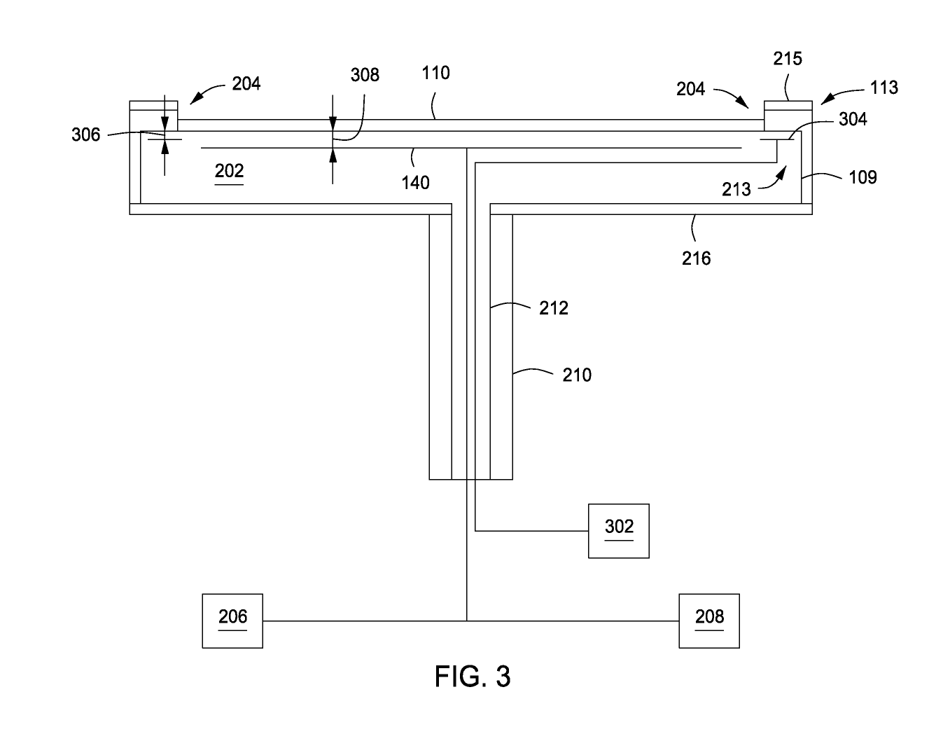

In some embodiments, the electrostatic chuck 109 may comprise two separate electrodes (e.g. electrode 140 and second electrode (conductive mesh) 304 shown) disposed within the puck 202, such as shown in FIG. 3. The second electrode 304 may be fabricated from the same, or in some embodiments, a different material, than the electrode 140. In addition, the second electrode 304 may have the same, or in some embodiments, a different density, than the electrode 140.

In some embodiments, the second electrode 304 may be disposed such that a substrate 110 to second electrode 304 distance 306, is the same, or different than that of the substrate 110 to electrode 140 distance 308.

In some embodiments, a second power source 302 may be coupled to the second electrode 304 to provide power to the second electrode 304. The second power source 302 may be an RF power source or DC power source. In embodiments where the second power source 302 is an RF power source, the second power source 304 may provide any amount of RF power at any frequency suitable to perform a desired process, for example, such as the power and frequencies discussed above. By providing the second power source 302, the inventors have discovered that a more uniform electromagnetic field may be produced above the substrate 100 (such as described above), thereby reducing or eliminating a bending of the plasma sheath (as described above), thus reducing or preventing non-uniform etching of the substrate 110.

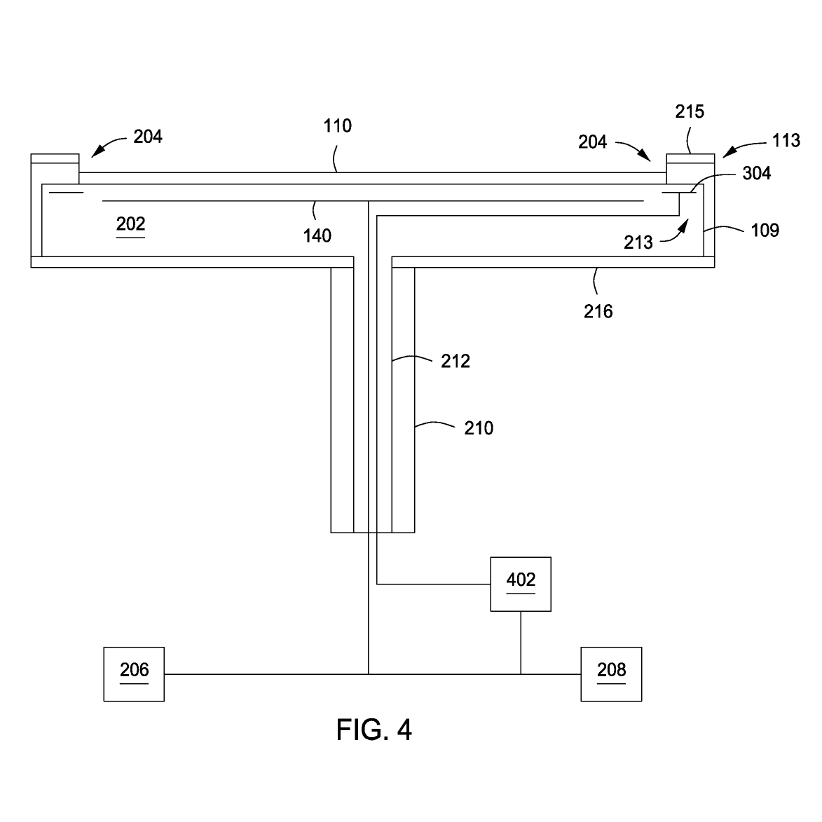

Alternatively, in some embodiments, the second electrode 304 may be powered by the same power sources (e.g. power sources 206, 208) utilized to power the electrode 140, such as shown in FIG. 4. In such embodiments, a variable capacitor or divider circuit (shown at 402) may be disposed between the power sources 206, 208 and the second electrode 304 to facilitate selectively providing power to the additional electrode.

Thus, an electrostatic chuck has been provided herein. Embodiments of the inventive electrostatic chuck may advantageously provide an electrostatic chuck capable of producing a more uniform electromagnetic field above a substrate disposed atop the electrostatic chuck during plasma processing processes (e.g., etch processes) thereby reducing or eliminating a bending of a plasma sheath of a plasma formed above the substrate, thus reducing or preventing non-uniform etching of the substrate. The inventive electrostatic chuck may further advantageously provide a more uniform temperature gradient proximate the edge of the substrate, thus reducing process non-uniformities and providing improved critical dimension uniformity as compared to conventionally utilized electrostatic chucks.

While the foregoing is directed to embodiments of the present invention, other and further embodiments of the invention may be devised without departing from the basic scope thereof.

1. An electrostatic chuck for supporting and retaining a substrate having a given width, comprising:
a dielectric member having a support surface configured to support a substrate having a given width;
an electrode disposed within the dielectric member beneath the support surface and extending from a center of the dielectric member outward to an area beyond an outer periphery of the substrate as defined by the given width of the substrate;
an RF power source coupled to the electrode; and
a DC power source coupled to the electrode.

2. The electrostatic chuck of claim 1, wherein the dielectric member is fabricated from alumina (Al₂O₃) or silicon nitride (SiN).

3. The electrostatic chuck of claim 1, further comprising:
a process kit disposed atop the electrostatic chuck to cover portions of the dielectric member and having a central opening corresponding to the support surface; and
a thermally conductive layer disposed atop the process kit, wherein the thermally conductive layer has a thermal conductivity substantially similar to a thermal conductivity of a substrate to be processed.

4. The electrostatic chuck of claim 3, wherein the process kit is fabricated from silicon oxide (SiO₂).

5. The electrostatic chuck of claim 3, wherein the thermally conductive layer comprises silicon carbide (SiC) or doped diamond.

6. The electrostatic chuck of claim 3, wherein the electrode extends to an area beneath the process kit.

7. The electrostatic chuck of claim 1, wherein the electrode is a conductive mesh.

8. The electrostatic chuck of claim 1, further comprising:
a plate disposed beneath the dielectric member to support the dielectric member; and
a support pedestal disposed beneath the plate to support the plate, the pedestal having a conduit disposed within the pedestal, wherein the conduit is configured to allow the RF power source and the DC power source to be coupled to the electrode.

9. An electrostatic chuck for supporting and retaining a substrate having a given width, comprising:
a first electrode disposed within a dielectric member of an electrostatic chuck and passing through a central axis perpendicular to a support surface of the electrostatic chuck;
a second electrode disposed within the dielectric member and at least partially radially outward of the first electrode, wherein the second electrode extends radially outward to an area beyond an outer periphery of the substrate as defined by the given width of the substrate;
an RF power source and a DC power source each coupled to the first electrode; and
an RF power source coupled to the second electrode.

10. The electrostatic chuck of claim 9, wherein the first electrode extends to an area proximate an edge of the substrate.

11. The electrostatic chuck of claim 9, wherein the dielectric member is fabricated from alumina (Al₂O₃) or silicon nitride (SiN).

12. The electrostatic chuck of claim 9, wherein the RF power source coupled to the second electrode is the same RF power source as is coupled to the first electrode.

13. The electrostatic chuck of claim 9, further comprising a variable capacitor or divider circuit to selectively divide the RF power delivered from the RF power source to the first and second electrodes.

14. The electrostatic chuck of claim 9, wherein the RF power source coupled to the second electrode is a different RF power source than the one coupled to the first electrode.

15. The electrostatic chuck of claim 9, further comprising:
a process kit disposed atop the electrostatic chuck to cover portions of the dielectric member and having a central opening corresponding to the support surface; and
a thermally conductive layer disposed atop the process kit, wherein the thermally conductive layer has a thermal conductivity substantially similar to a thermal conductivity of a substrate to be processed.

16. The electrostatic chuck of claim 14, wherein the process kit is fabricated from silicon oxide (SiO₂).

17. The electrostatic chuck of claim 14, wherein the thermally conductive layer comprises silicon carbide (SiC) or doped diamond.

18. The electrostatic chuck of claim 14, wherein the second electrode extends to an area beneath the process kit.

19. The electrostatic chuck of claim 9, wherein at least one of the first electrode or the second electrode is a conductive mesh.

20. The electrostatic chuck of claim 9, further comprising:
a plate disposed beneath the dielectric member to support the dielectric member; and
a support pedestal disposed beneath the plate to support the plate, the pedestal having a conduit disposed within the pedestal, wherein the conduit is configured to allow the RF power source and the DC power source to be coupled to the electrode.
